(19) United States
(12) Patent Application Publication
(10) Pub. No.: US 2013/0335282 A1
(43) Pub. Date: Dec. 19, 2013

(54) OMNIDIRECTIONAL CIRCULARLY POLARIZED DIELECTRIC ANTENNA

(71) Applicants: Kwok Wa LEUNG, New Territories (HK); Yongmei PAN, New Territories (HK)

(72) Inventors: Kwok Wa LEUNG, New Territories (HK); Yongmei PAN, New Territories (HK)

(73) Assignee: CITY UNIVERSITY OF HONG KONG, Kowloon (HK)

(21) Appl. No.: 13/495,462

(22) Filed: Jun. 13, 2012

(51) Int. Cl. H01Q 15/24

(52) U.S. Cl. 343/756

(57) ABSTRACT

An omnidirectional circularly polarized (CP) antenna resembling a bird nest is provided. A center feeding probe (monopole antenna) capable of emitting an omnidirectional linearly polarized (LP) radiation pattern is electrically coupled to dielectric parallelepipeds. The dielectric parallelepipeds are evenly spaced with uniform angular intervals that angularly surround the probe; effectively acting as a polarizer capable of converting the omnidirectional LP radiation pattern into an omnidirectional CP radiation pattern.

### BACKGROUND OF THE INVENTION

1. Technical Field

The present invention generally relates to circularly polarized (CP) antennas. More particularly, the present invention relates to an omnidirectional CP antenna with grating dielectric elements acting as a polarizer to convert a linearly polarized omnidirectional radiation pattern from a monopole antenna to an omnidirectional CP radiation pattern.

2. Background Information

With the rapid development of mobile communications, uses of satellite communications have been more extensive than ever. Circularly polarized (CP) conical-beam antennas are often required for communications between moving vehicles on the earth and geostationary satellites, because they can alleviate multipath problems caused by reflections from building walls and the ground surface. Also, they can provide larger signal coverage. However, while various CP antenna designs providing conical beams have been proposed, their configurations are relatively complex or their performance thus far remains unsatisfactory.

Thus, a need exists for an improved CP antenna design with better performance.

### SUMMARY OF THE INVENTION

Briefly, the present invention satisfies the need for an improved CP antenna design by providing an omnidirectional or conical-beam CP antenna integrating a monopole feeding probe with a polarizer comprised of grating dielectric elements (e.g., parallelepipeds). The probe is surrounded by the grating dielectric elements, preferably evenly distributed about the feeding probe. Since the structure can resemble a bird nest, it is referred to as a bird-nest antenna. A prototype with parallelepipeds was constructed having a very wide axial ratio (AR) bandwidth of 54.9%, although the overall antenna bandwidth is limited by the impedance bandwidth of 41.0%.

A parametric study of the proposed antenna was done to review the effects of various design parameters, and a design guideline is given herein to help engineers design the antenna. To verify the design guideline, it was used to design a second bird-nest antenna operating at a different frequency. The guideline provides reasonable initial values for various design parameters, based on which an optimum design can readily be obtained.

More broadly, the present invention provides, in a first aspect, an omnidirectional circularly polarized (CP) antenna. The antenna comprises a feeding probe capable of emitting a linearly polarized (LP) omnidirectional radiation pattern, and a polarizer electrically coupled to the feeding probe. The polarizer comprises a plurality of grating dielectric elements, and is capable of converting the LP radiation pattern into an omnidirectional CP radiation pattern.

The present invention provides, in a second aspect, a method of generating an omnidirectional circularly polarized (CP) radiation pattern. The method comprises providing an omnidirectional CP antenna, the antenna comprising a feeding probe capable of emitting an omnidirectional linearly polarized (LP) radiation pattern, and a polarizer electrically coupled to the feeding probe, the polarizer comprising a plurality of grating dielectric elements. The method further comprises exciting the feeding probe to emit an omnidirectional LP radiation pattern, and converting the LP radiation pattern to an omnidirectional CP radiation pattern via the polarizer.

These, and other objects, features and advantages of this invention will become apparent from the following detailed description of the various aspects of the invention taken in conjunction with the accompanying drawings.

### BRIEF DESCRIPTION OF THE DRAWINGS

FIG. 1 depicts an E-field travelling in a dielectric wave polarizer.

FIG. 2 depicts an example geometry for a dielectric parallelepiped element according to an aspect of the invention.

FIG. 3(a) depicts a perspective view of an example bird-nest antenna configuration according to the invention.

FIG. 3(b) depicts a top view of the antenna of FIG. 3(a) having N dielectric parallelepipeds.°

FIG. 4 is a graph of measured and simulated reflection coefficients for an example bird-nest antenna similar to FIGS. 3(a) and 3(b), having the following parameters: ∈ᵣ (dielectric constant)=15, N=8, l (24, FIG. 2)=62 mm, w (28, FIG. 2)=6 mm, d (26, FIG. 2)=10 mm, α (22, FIG. 2)=30°, R (38, FIG. 3(a))=32.5 mm, s₀ (29, FIG. 3(b))=29.5 mm, rₚ (half of measurement 33, FIG. 3(a))=0.63 mm, and lₚ (31, FIG. 3(a))=13.5 mm.

FIG. 5 is a graph of simulated reflection coefficient for the example bird-nest antenna of FIG. 4 for ∈ᵣ=1, 5, 10, and 15 with other parameters the same as that of FIG. 4.

FIG. 6 is a graph of measured and simulated ARs of the example bird-nest antenna at θ (azimuth)=30° (see 300, FIG. 3(a)), and φ=0° (see 302, FIG. 3(a)), with the remaining parameters the same as that of FIG. 4.

FIGS. 7(a)-7(c) are graphs of measured and simulated radiation patterns of the example bird-nest antenna of FIG. 4 at 4.3 GHz, 5.3 GHz and 6.3 GHz, respectively.

FIG. 8 is a graph of a simulated elevation angle of maximum field and the corresponding antenna gain, along with the antenna gain simulated at a fixed elevation angle of θ=30° for the example antenna, with the remaining parameters the same as that of FIG. 4.

FIG. 9 is a graph of measured and simulated antenna gains of the bird-nest antenna at θ=30°, φ=0°, with the remaining parameters the same as that of FIG. 4.

FIGS. 10(a)-10(c) are graphs of simulated reflection coefficient, AR, and radiation pattern (θ=30°), respectively, of the bird-nest antenna for N=4, 8, and 12, with the parallelepiped dimensions given in Table 1.

FIGS. 11(a) and (b) are graphs of simulated reflection coefficient and AR, respectively, of the bird-nest antenna as a function of frequency for different parallelepiped widths of w=4, 6, and 8 mm, with the remaining parameters the same as that of FIG. 4.

FIGS. 12(a) and (b) are graphs of simulated reflection coefficient and AR, respectively, of the example bird-nest antenna as a function of frequency for different parallelepiped depths of 8, 10, and 12 mm, with the remaining parameters the same as that of FIG. 4.

FIGS. 13(a) and (b) are graphs of simulated reflection coefficient and AR, respectively, of the example bird-nest antenna as a function of frequency for different parallelepiped lengths of 57, 62, and 67 mm, with the remaining parameters the same as that of FIG. 4.

FIGS. 14(a) and (b) are graphs of simulated reflection coefficient and AR, respectively, of the example bird-nest antenna as a function of frequency for different probe lengths of 13.5, 14.5, and 15.5 mm, with the remaining parameters the same as that of FIG. 4.

FIGS. 15(a) and (b) are graphs of simulated reflection coefficient and AR, respectively, of the example bird-nest antenna as a function of frequency for different ground plane radii of R=27.5, 32.5, and 37.5 mm, with the remaining parameters the same as that of FIG. 4.

FIGS. 16(a) and (b) are graphs of simulated reflection coefficient and AR, respectively, of the bird-nest antenna as a function of frequency for different dielectric constants of 10, 15, 25 and 40, with the remaining design parameters given in Table II.

FIGS. 17(a) and (b) are graphs of simulated reflection coefficient and AR, respectively, of the bird-nest antenna designed at 8 GHz, with the remaining design parameters given in Table III.

### DETAILED DESCRIPTION OF THE INVENTION

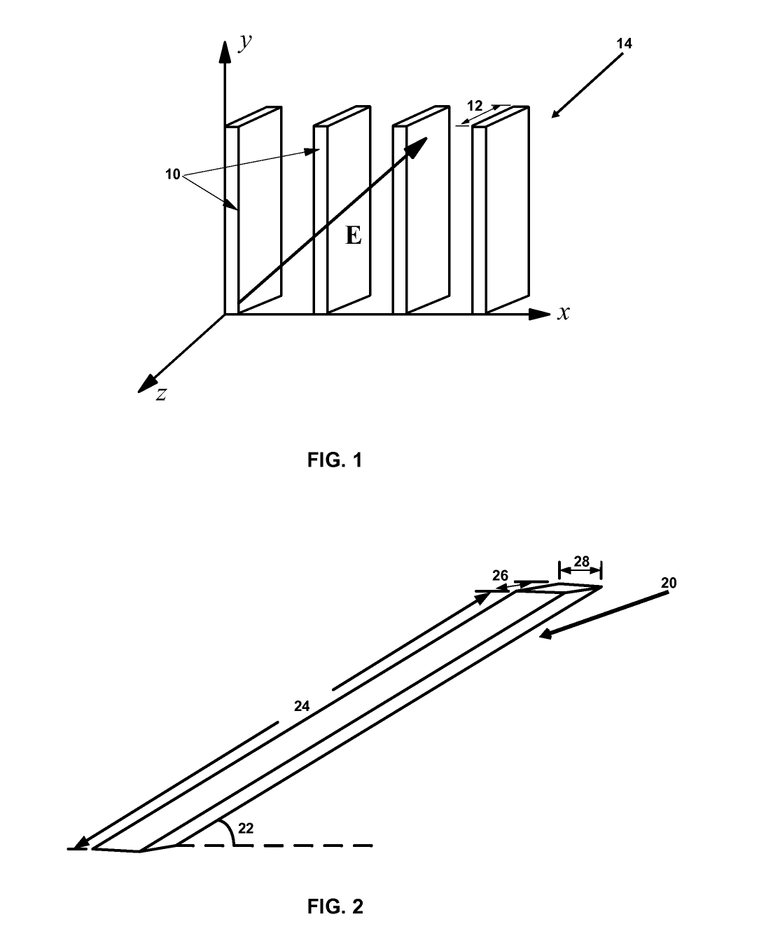

To understand the invention, one needs to understand a wave polarizer. Thus, the basic principle of a wave polarizer will briefly be explained. FIG. 1 shows a wave polarizer 14 that consists of grating dielectric slabs 10 with a depth of 12. It is assumed that an LP wave traveling in the z direction has a polarization angle of 45° with respect to the positive x axis. The E-field of the wave can then be resolved into ∈ₓ and ∈_{y} components. Since the dielectric slabs and air regions effectively behave as an anisotropic dielectric, the two field components will travel at different velocities as the wave passes through the polarizer, causing them to have a phase difference between each other. By tuning the slab depth, a phase difference of 90° can be obtained and a CP wave results when |∈ₓ|=|∈_{y}|.

From the above principle, the present invention infers that an omnidirectional CP antenna can be obtained when a source that radiates omnidirectional LP fields is angularly surrounded by a polarizer. In the main example, the source is a coaxial probe that also simultaneously functions as a monopole antenna. Since the field excited by a monopole antenna is predominantly vertically polarized, inclined dielectric slabs are used to obtain the polarizer effect. In the present example, the probe comprises an inner conductor of a subminiature version A (SMA) radio frequency (RF) coaxial connector.

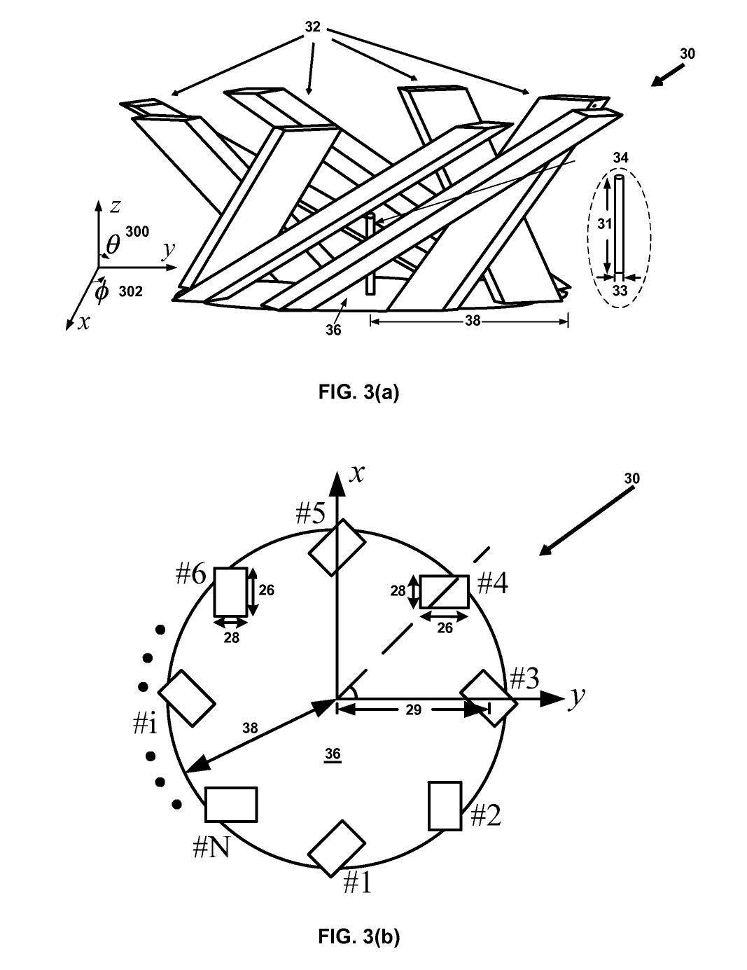

When the depth of the dielectric slabs is not large, the slabs effectively become parallelepipeds. FIG. 2 shows one example of a parallelepiped element 20, which has a length 24, a width 28, a depth 26, and an inclination angle 22. FIG. 3(a) shows the configuration of the proposed omnidirectional CP bird-nest antenna 30. With reference to FIG. 3(a), the probe 34 has a length 31 and a radius of half that of dimension 33, while the circular ground plane 36 has a radius 38. FIG. 3(b) shows the top view of the proposed configuration 30. The N parallelepipeds are evenly distributed along the circumference of the ground plane, with a uniform angular interval of 360°/N. Each parallelepiped has a displacement 29 from the center of the ground plane. The proposed antenna of FIG. 3 generates left-hand CP (LHCP) fields. Right-hand CP (RHCP) fields can be generated by rotating the base of each parallelepiped by 90°.

Of course, it will be understood that the dielectric elements can have shapes other than the parallelepipeds shown. For example, the dielectric elements can have a curved shape, a shape pattern along a length thereof, and/or a corrugated shape pattern. Preferably, the dielectric elements have a dielectric constant of about 7 to about 50.

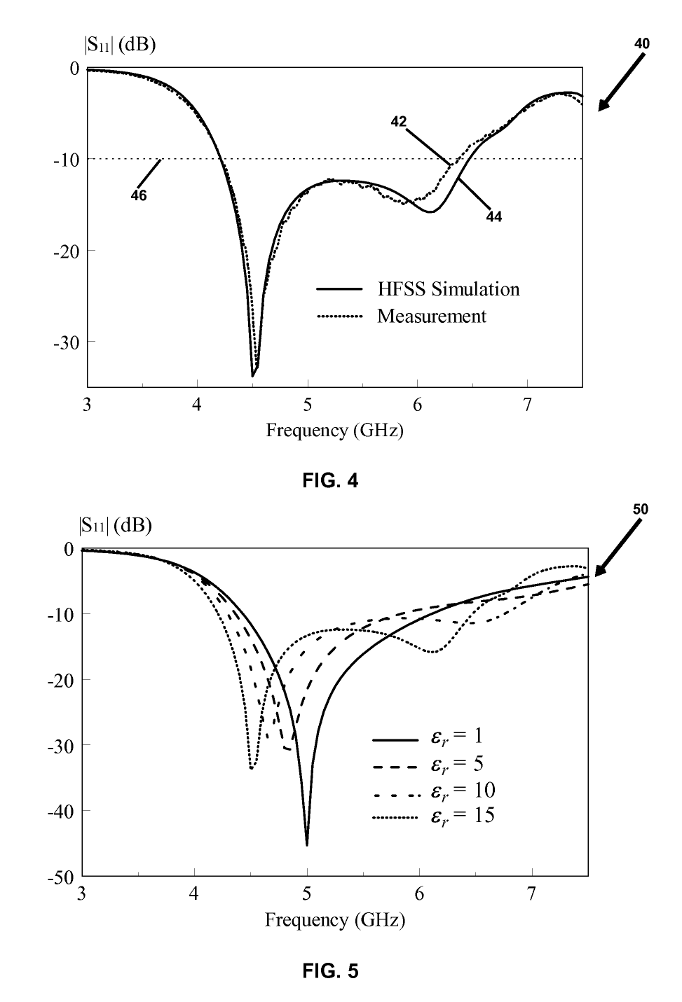

A prototype CP bird-nest antenna similar to FIG. 3, operating in C band was designed, fabricated, and tested. The prototype had parameters of ∈ᵣ (dielectric constant)=15, N=8, l=62 mm, w=6 mm, d=10 mm, α=30°, R=32.5 mm, s₀=29.5 mm, rₚ=0.63 mm, and lₚ=13.5 mm. See FIGS. 3(a) and 3(b) and the brief description of FIG. 4 for an identification of parameters.

For the prototype, the reflection coefficient was measured using an HP8510C network analyzer, while the AR, radiation pattern, and antenna gain were measured using a Satimo Startlab System.

FIG. 4 is a graph 40 of the measured 42 and simulated 44 reflection coefficients of the prototype. The measured 10-dB impedance bandwidth 46 (|S₁₁|<−10 dB) is 41.0% (4.21-6.38 GHz), which agrees quite well with the simulated value of 42.5% (4.20-6.47 GHz). The first and second resonances in the passband are caused by the probe (monopole) and dielectric parallelepipeds, respectively. To verify this, the reflection coefficient of the bird-nest antenna was simulated for ∈ᵣ=1, 5, 10, and 15 and the results are shown in the graph 50 of FIG. 5. The other parameters remain unchanged from the prototype parameters given with the brief description of FIG. 4. It is worth mentioning that when ∈ᵣ=1, the dielectric parallelepipeds effectively vanish and only the probe remains. In this case, a single resonant mode resonating at 5.0 GHz is obtained as seen from the figure. When ∈ᵣ increases from 1 to 15, the frequency of the mode gradually decreases from 5.0 GHz to 4.5 GHz, showing that the resonance at 4.5 GHz of the prototype is associated with the probe. With reference to the figure, a second resonance appears in the upper region and becomes stronger as ∈ᵣ increases, verifying that the second resonance is caused by the dielectric parallelepipeds. Because of this second resonance, the impedance bandwidth of the antenna can be broadened from about 37.5% (∈ᵣ=1) to about 42.5% (∈ᵣ=15).

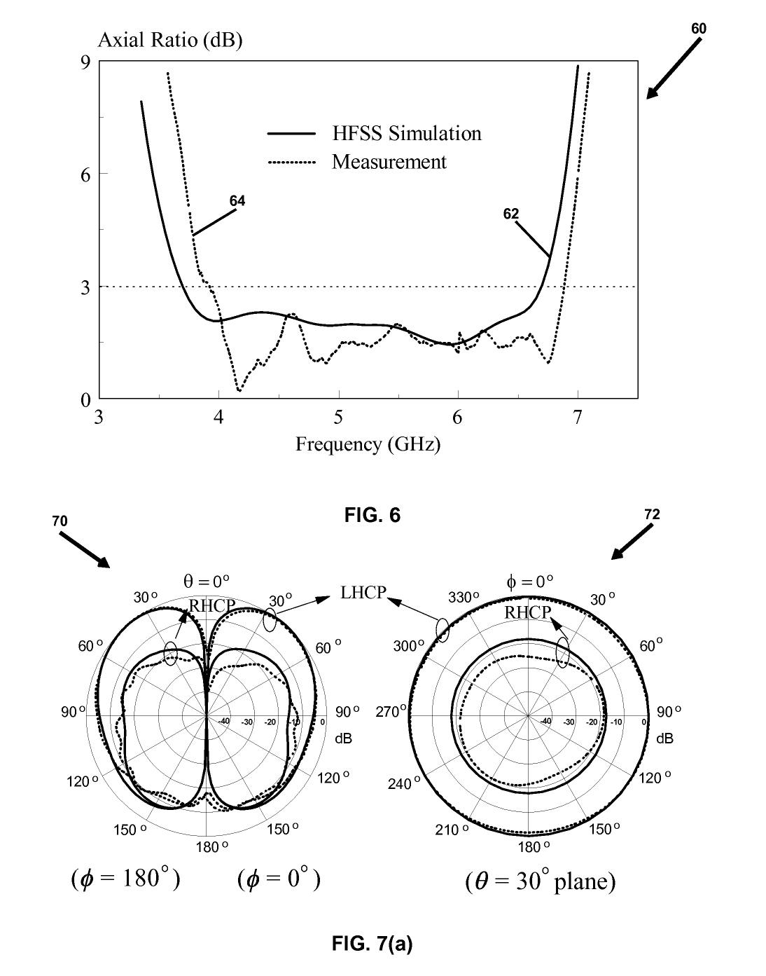

FIG. 6 is a graph 60 of the simulated 62 and measured 64 ARs of the prototype bird-nest antenna at θ=30°, φ=0°. With reference to the figure, reasonable agreement between the simulated and measured results is obtained, with the discrepancy caused by tolerances and imperfections of the experiment. The simulated and measured 3-dB AR (AR<3 dB) bandwidths are 57.7% (3.70-6.70 GHz) and 54.9% (3.92-6.89 GHz), respectively. The AR was also simulated and measured at other values of φ with θ=30° and similar results were obtained, showing that it is a good omnidirectional antenna. It is worth mentioning that both the measured and simulated impedance passbands completely fall within their respective AR passbands, therefore the entire impedance bandwidth is usable. Although the overall antenna bandwidth is limited by the impedance bandwidth, it is as wide as 41% (4.21-6.38 GHz), which is sufficient for many wireless systems.

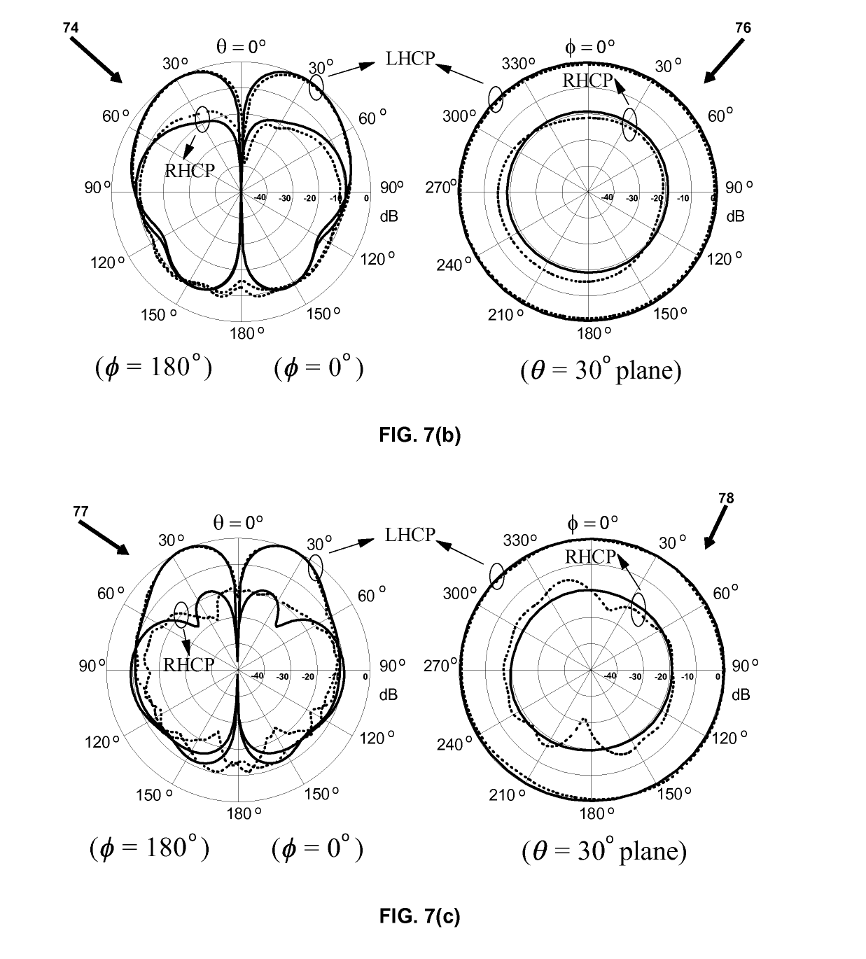

FIGS. 7(a)-(c) are graphs 70-78 of the simulated (solid) and measured (dashed) radiation patterns in the elevation and azimuth (θ=30°) planes at 4.3 GHz, 5.3 GHz, and 6.3 GHz, respectively. With reference to the figures, the elevation pattern has a null in the boresight direction (θ=0°) whereas the azimuthal pattern is omnidirectional. As can be observed from FIGS. 7(a) to 7(c), the elevation angle θ₀ that gives the maximum radiation becomes smaller as the frequency increases. This effect is caused by the fact that the electrical size of the ground plane increases with frequency. In each elevation plane, the co-polarized (LHCP) field at θ₀ is at least ˜15 dB stronger than the corresponding cross-polarized (RHCP) counterpart. The co-polarized field is also at least ˜15 dB stronger than the cross-polarized field for each azimuth plane. The field patterns in the φ=90° plane were also measured and simulated at the three frequencies. Similar results were obtained, which is expected due to the symmetry of the structure. The radiation patterns were simulated at other frequencies and very stable results were obtained across the entire passband.

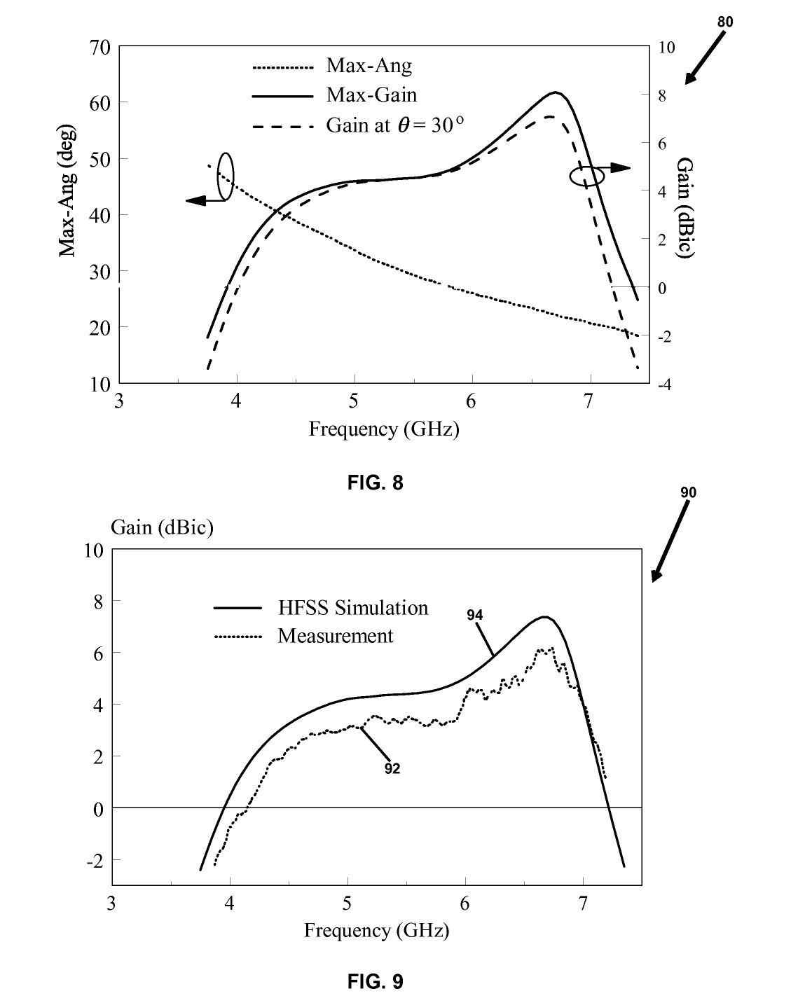

As discussed above, θ₀ is not a constant but changes with frequency. FIG. 8 is a graph 80 of θ₀ (y axis) as a function of frequency (x axis). With reference to the figure, as the frequency increases from 4.21 to 6.38 GHz, θ₀ decreases from 42° to 24° and the radiai°n beam lifts upward. The simulated antenna gain (solid line) at θ₀ is also shown in the figure, along with the simulated gain at a fixed elevation angle of θ=30°. It is interesting to note from the figure that the two gain curves are quite similar to each other. Their gain values are about the same at around the mid-band frequency of 5.3 GHz, which is expected because θ₀ is also equal to 30° at 5.3 GHz.

FIG. 9 is a graph 90 of the measured 92 and simulated 94 antenna gains of the bird-nest antenna at θ=30°, φ=0° and reasonable agreement between them is found. With reference to the figure, two peaks can be observed at ˜5.0 GHz and ˜6.7 GHz, although the first peak is not as obvious as the second one. The first peak is caused by the monopole mode of the probe, which can be seen from the fact that its frequency (˜5.0 GHz) is the same as for the ∈ᵣ=1 case of FIG. 5. For the second peak, it is due to the dielectric-parallelepiped mode as discussed before. As compared with the reflection coefficient of FIG. 4, it is obvious that the peak-gain frequencies are different from the matching frequencies. This is not surprising because radiated fields are only related to the input resistance of the antenna, whereas the reflection coefficient depends on both the input resistance and reactance.

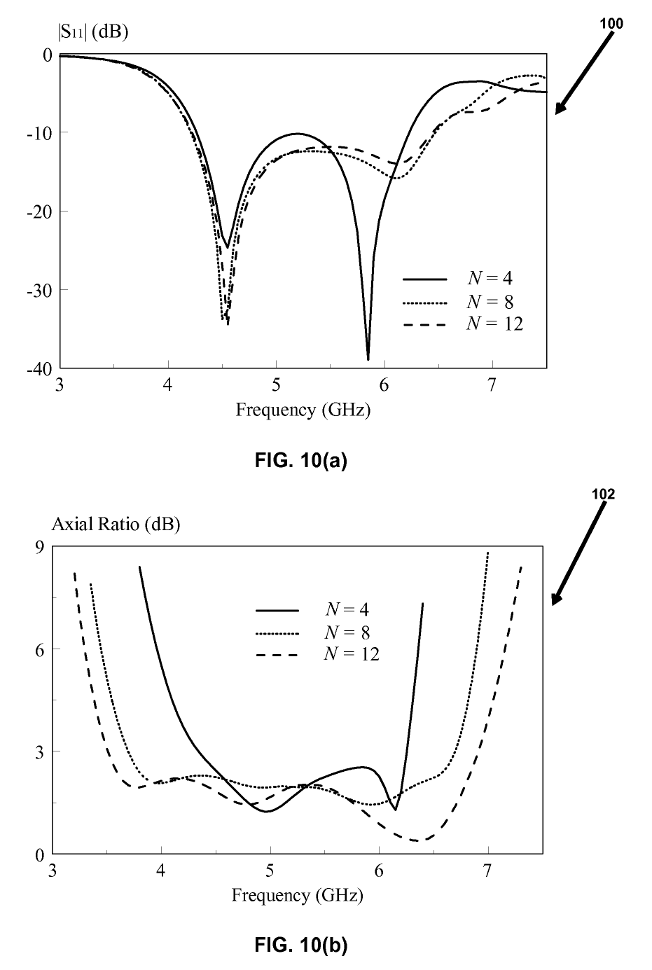

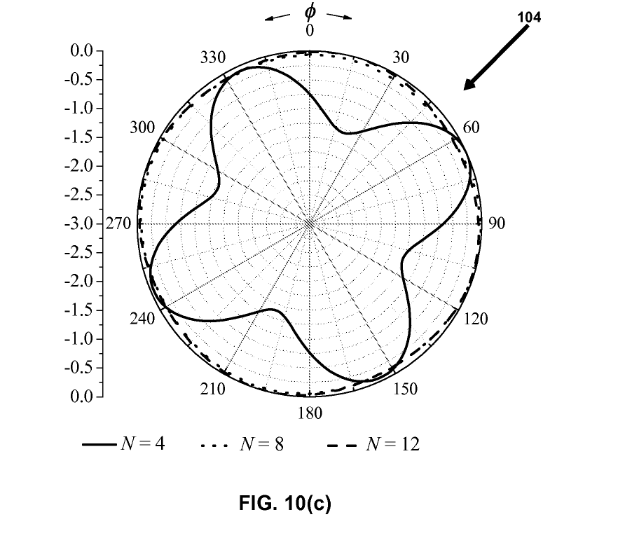

To characterize the example bird-nest antenna, a parametric study was carried out using Ansoft HFSS software. The effect of the number N of dielectric parallelepipeds was studied first. Three bird-nest antennas of N=4, 8, 12 were designed to operate at ˜5.3 GHz. In each case, only the dimensions of parallelepiped elements (width, depth, length) were tuned to optimize the antenna, whereas other parameters remained unchanged from the prototype. FIGS. 10(a) and 10(b) are graphs of the simulated reflection coefficient 100 and AR 102, respectively, for the three cases, while FIG. 10(c) shows their azimuthal radiation patterns 104 at 5.3 GHz. As shown in FIGS. 10(a) and 10(b), the antenna with N=4 has the impedance and AR bandwidths given by 37.6% and 35.8%, respectively. Although these bandwidths are satisfactory, it can be seen from FIG. 10(c) that the corresponding azimuthal radiation pattern is not omnidirectional. Instead, there is a ripple of ˜1.39 dB, which is the difference between the maximum and minimum gains. When N=8, the pattern becomes omnidirectional, and the AR bandwidth significantly increases from 35.8% to 57.7%. Similar results are obtained for N=12. As a result, N=8 is used in the main example here. Table I below summarizes the antenna dimensions, bandwidths, and ripples of the patterns for the three cases. It is noted from the table that a larger parallelepiped size is needed when a smaller N is used to maintain a certain effective dielectric constant of the antenna structure.

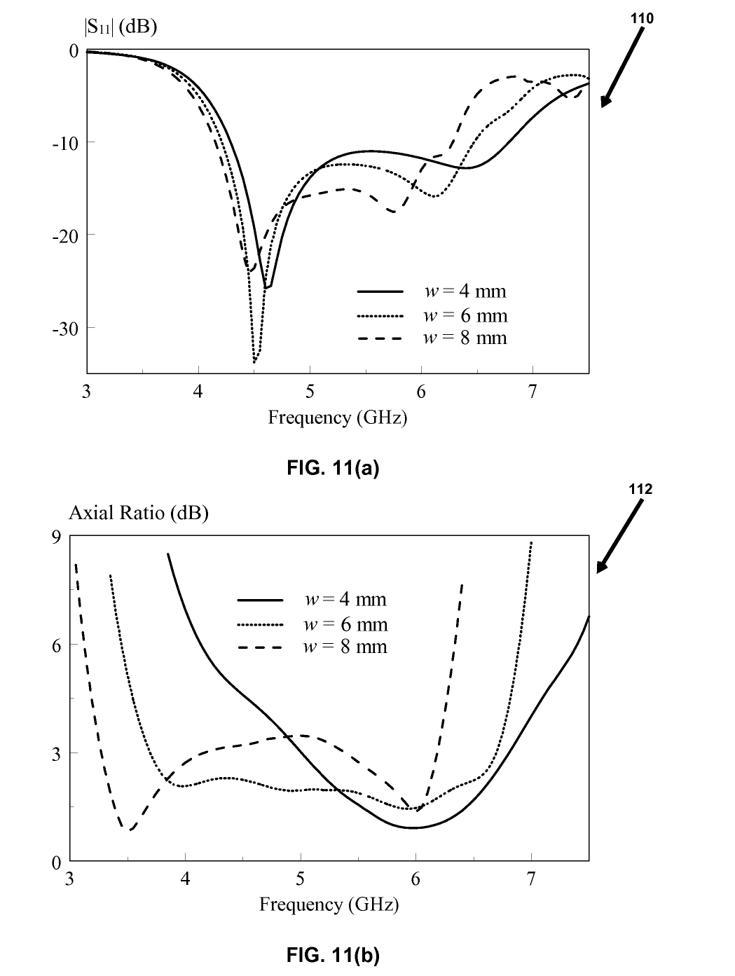

The effects of parallelepiped dimensions were also investigated. FIGS. 11(a) and 11(b) are graphs of the simulated reflection coefficient 110 and AR 112, respectively, for different parallelepiped widths of w=4, 6, and 8 mm. As can be observed from FIG. 11(a), the upper band is more sensitive to w than for the lower one, verifying that the upper band is associated with the dielectric parallelepipeds as discussed before. It is noted that as w increases, the upper frequency shifts downward because of having a higher effective dielectric constant. With reference to FIG. 11(b), the parallelepiped width also affects AR significantly. The AR bandwidth is optimum, i.e., the widest, at w=6 mm when the 3-dB criteria is used.

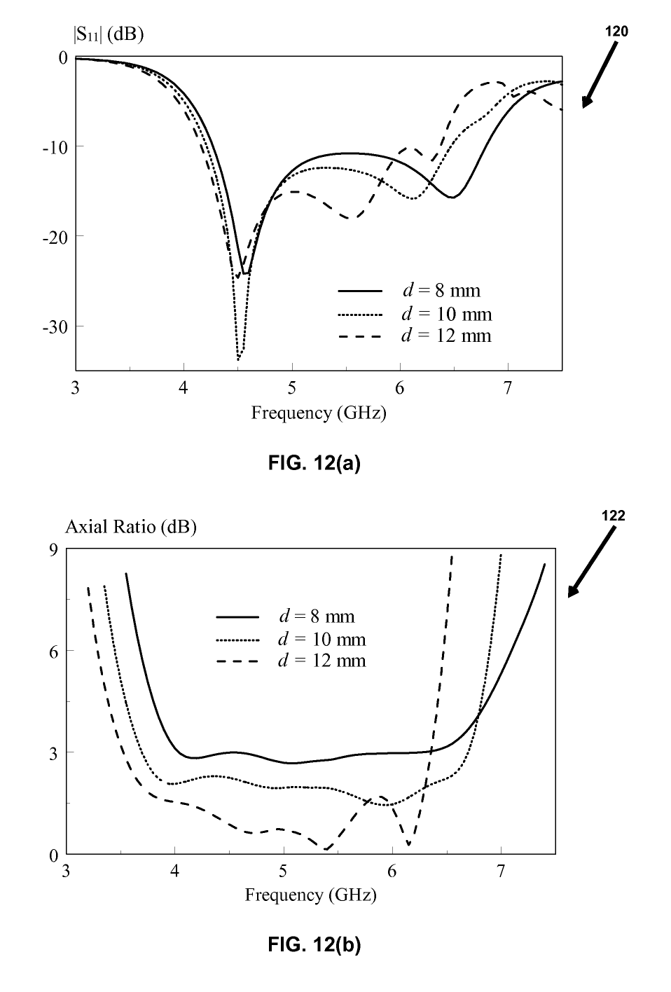

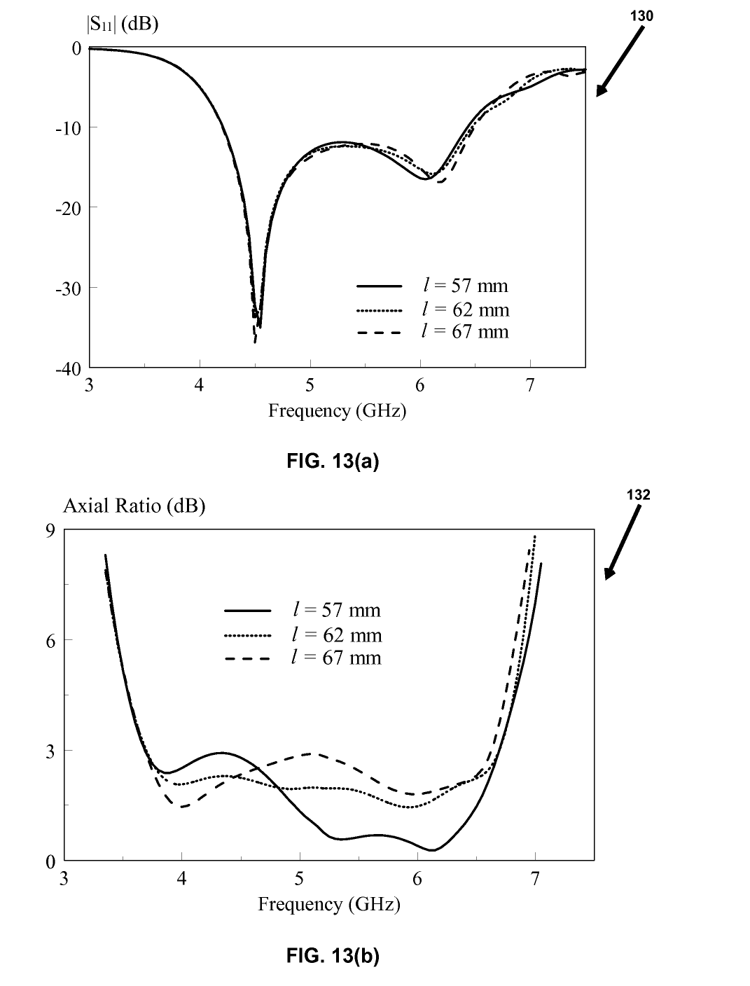

FIGS. 12(a) and (b) are graphs of simulated reflection coefficient 120 and AR 122, respectively, using different parallelepiped depths of d=8, 10, and 12 mm. With reference to FIG. 12(a), d also has a larger effect on the upper band of the reflection coefficient than for the lower band, verifying again that the upper band is caused by the dielectric parallelepipeds. With reference to FIG. 12(b), d affects the entire AR level; the average AR value over the 3-dB AR passband decreases from ˜2.8 dB to ˜1.1 dB as d increases from 8 mm to 12 mm. FIGS. 13(a) and 13(b) are graphs of simulated reflection coefficient 130 and AR 132, respectively, showing the effect of parallelepiped length. It can be seen from FIGS. 13(a) and 13(b) that the length has negligible effects on the impedance level, but affects the AR significantly. Therefore, if the antenna is already matched, parallelepiped length can be used to fine tune the AR.

Table I is a comparison of parallelepiped dimensions, bandwidths, and pattern ripples of different bird-nest antennas with N=4, 8, and 12: ∈ᵣ=15, α=30°, R=32.5 mm, s₀=29.5 mm, lₚ=13.5 mm, and rₚ=0.63 mm.

TABLE I

| | Dielectric | | | Pattern |
|---|---|---|---|---|
| Number of | slab size | Impedance | AR | Ripple |
| elements N | w × d × l (mm) | Bandwidth | Bandwidth | (dB) |
| 4 | 6.1 × 11.4 × 67 | 37.6% | 35.8% | 1.39 |
| 8 | 6.0 × 10.0 × 62 | 42.5% | 57.7% | 0.07 |
| 12 | 4.5 × 10.0 × 60 | 41.8% | 65.3% | 0.12 |

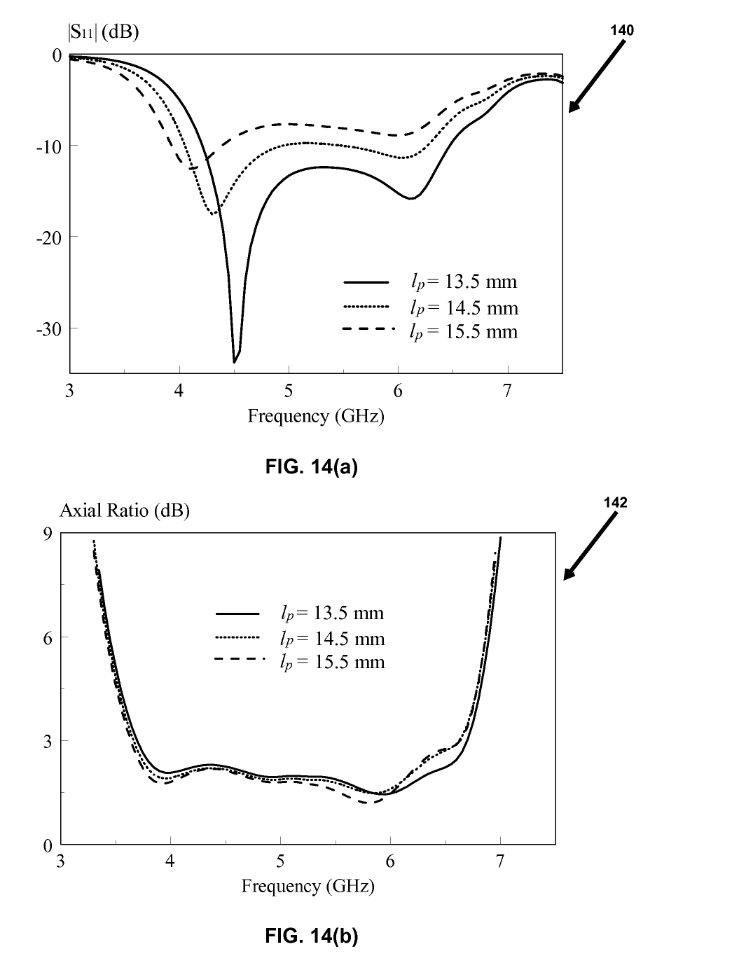

Next, the effect of the probe length was investigated. FIGS. 14(a) and 14(b) are graphs of the simulated reflection coefficient 140 and AR 142, respectively, as a function of frequency for probe lengths of 13.5, 14.5, and 15.5 mm. With reference to FIG. 14(a), probe length has stronger effects on the lower band than for the upper band, which is consistent with the fact that lower resonance is caused by the monopole mode of the probe. From FIG. 14(b), it can be observed that the effect of probe length on AR is negligible. It suggests that after the AR is optimized, the length can be adjusted to match the antenna without the need to worry about the AR. This is a favorable feature that can greatly facilitate designs of the CP antenna.

It will be understood that the feeding probe can be other types and/or shapes. For example, the probe can be a meander probe or have a cone-like shape.

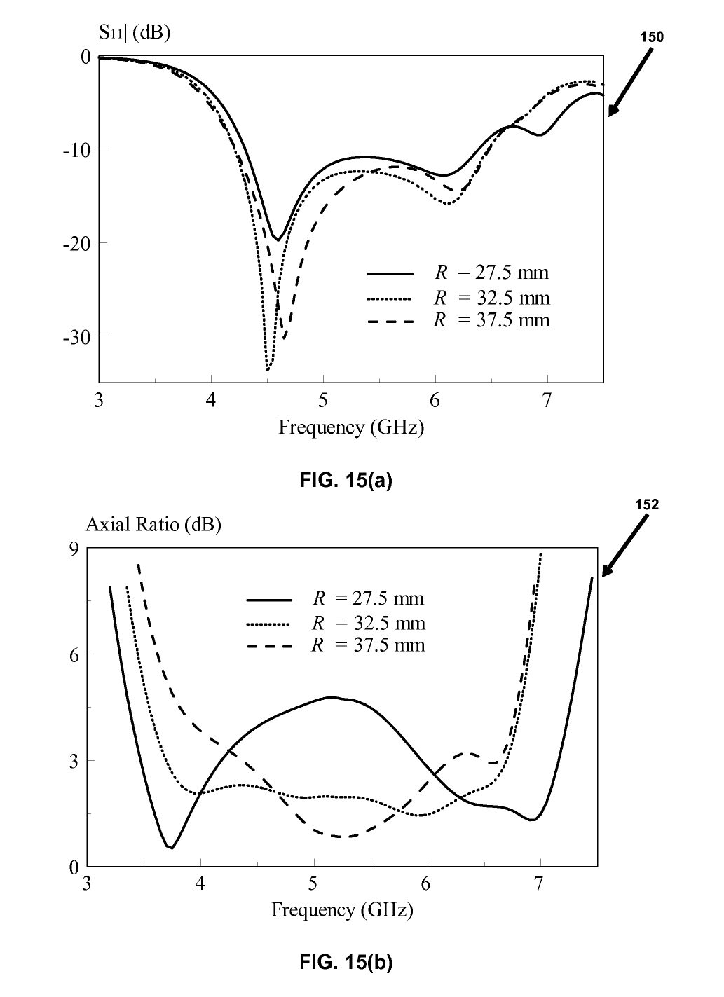

For a conical-beam antenna, the ground-plane size usually affects the antenna performance considerably. Therefore, the effect of circular ground-plane size was studied. FIGS. 15(a) and (b) are graphs of the simulated reflection coefficient 150 and AR 152, respectively, for different ground plane radii of R=27.5, 32.5, and 37.5 mm. As can be observed from the figures, although good match is maintained across the impedance passband for the different values of R, both the lower and upper AR bands are affected significantly. When R is small (27.5 mm), the two AR bands become totally separate from each other. But as R increases, the two bands approach each other and finally merge together. The optimum radius of the ground plane that gives the widest AR bandwidth for the present design is given by R=32.5 mm, which is 0.57λ₀ at the mid-band frequency of 5.3 GHz, with λ₀ being the wavelength in air.

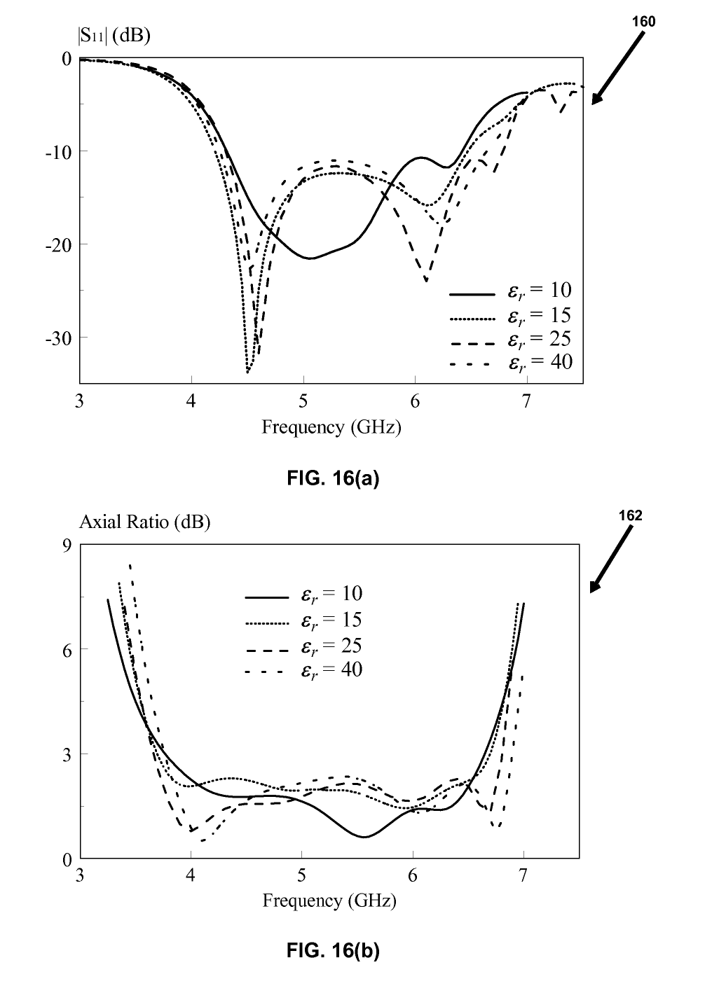

The effect of ∈ᵣ (dielectric constant) of the parallelepiped elements was also studied. Four bird-nest antennas with ∈ᵣ=10, 15, 25 and 40 were designed to operate at ˜5.3 GHz. In each case, the dimensions of dielectric parallelepipeds, probe, and ground plane were tuned to optimize the bandwidth. FIGS. 16(a) and 16(b) are graphs of the reflection coefficient 160 and AR 162, respectively, of the antennas. With reference to the figures, although the shapes of the curves are somewhat different as ∈ᵣ increases from 10 to 40, both the impedance and AR bandwidths remain almost unchanged, as given by ˜40% and ˜55%, respectively. Table II below summarizes the optimized antenna dimensions and bandwidths. As can be observed from the table, a larger parallelepiped is needed for a smaller ∈ᵣ to maintain a certain effective ∈ᵣ, as expected. Therefore, ∈ᵣ cannot be too low or the dielectric parallelepipeds would be too large to be placed on the ground plane without any intersections. On the other hand, ∈ᵣ cannot be too high either or the parallelepiped elements would be too small to be fabricated accurately. For example, as found in Table II, the width is only 1.9 mm when ∈ᵣ=40. Therefore, a medium ∈ᵣ in the range of 10-40 is preferred for designs of the antenna of the present invention.

Table II below is a comparison of parallelepiped dimensions and bandwidths of different bird-nest antennas with ∈ᵣ=10, 15, 25, and 40:α=30°, s₀=29.5 mm, rₚ=0.63 mm.

TABLE II

| | Dielectric | Ground | | | |
|---|---|---|---|---|---|
| Dielectric | slab size | plane | Probe | | |
| constant | w × d × l | radius—R | length | Impedance | AR |
| εᵣ | (mm) | (mm) | lₚ (mm) | Bandwidth | Bandwidth |
| 10 | 7.2 × 14.8 × 66 | 29.5 | 13.0 | 39.3% | 55.5% |
| 15 | 6.0 × 10.0 × 62 | 32.5 | 13.5 | 42.5% | 57.7% |
| 25 | 3.4 × 10.0 × 62 | 32.5 | 13.0 | 44.8% | 60.0% |
| 40 | 1.9 × 9.8 × 68 | 32.5 | 13.5 | 43.9% | 58.9% |

The effect of the displacement s₀ (29, FIG. 3(b)) of parallelepiped elements was also investigated. Three different cases of s₀=26, 29.5, and 33 mm were studied. It was found that s₀ has a much stronger effect on the upper band of the reflection coefficient than for the lower band. It was also found that varying s₀ can change the level of the AR and the result is similar to that of FIG. 12(b). The AR bandwidth is widest when s₀=29.5 mm. Finally, the effect of the inclination angle α of the parallelepiped elements was also investigated. Three antennas with α=25°, 30°, and 35° were simulated. It was observed that the reflection coefficient of the upper band varies with α significantly, whereas good match can be obtained for the lower band for all of the three cases. The AR is also affected by α. When α=25°, the upper-band AR is good, but the lower-band AR is unsatisfactory. The situation is reverse when α=35°. As a compromise, the middle value of α=30° is used in the prototype to maximize the AR bandwidth. The results of s₀ and α, however, are not included herein for brevity.

A suggested design guideline for a bird-nest antenna will now be given. It is assumed that the design frequency and wavelength in air are given by f₀ and λ₀, respectively.

(i) Parameters of probe (length lₚ, radius rₚ)

It has been found that the monopole mode of the probe dominates the response of the reflection coefficient. It has also been found that its natural resonance frequency (5.0 GHz) is around the center frequency (5.3 GHz) of the antenna. This suggests the monopole dimensions should be preferably designed first. An example follows.

Monopole length: lₚ=λ₀/4.

Monopole radius: 0.5 mm≦rₚ≦1.5 mm. As a practical matter, it may be convenient to choose rₚ=0.63 mm, as it is readily available in the commercial market.

(ii) Parameters of Dielectric Parallelepiped (s₀, w, d, l, α)

Since the dielectric parallelepiped elements form an effective polarizer, their locations and dimensions play important roles in getting wide AR bandwidths. As discussed before, an optimum response can be obtained when the dielectric parallelepipeds are placed at s₀˜2₀/2.

It was found that different sets of width, depth, and length can provide wide antenna bandwidths, therefore designers have the flexibility of using different dimension ratios for a given frequency f₀. A possible solution is to obtain the dimensions by simply scaling those of our designs as summarized in Table II. For example, the parallelepiped elements of our prototype has dimensions of w=6 mm, d=10 mm, and l=62 mm, as listed in the second row of Table II. The prototype has a mid-band (design) frequency of 5.3 GHz. When a new operating frequency of f_{c} GHz is needed, the dimensions of new parallelepiped elements can be given by w=(5.3/f_{c})×6 mm, d=(5.3/f_{c})×10 mm, l=(5.3/f_{c})×62 mm. If a new ∈ᵣ other than those of Table II (∈ᵣ=10, 15, 25 or 40) is used, the initial parallelepiped dimensions can be obtained by interpolating the values given in the table. For the inclination angle α of the dielectric parallelepipeds, its initial value can be chosen as α=30°.

(iii) Radius of Ground Plane (R)

It was found that good results can be obtained when the ground-plane radius R falls in the range of s₀≦R≦s₀+0.1λ₀.

It should be mentioned that the guideline suggests initial values of design parameters only and fine-tuning the parameters is recommended to optimize the antenna. Fine tuning can include, for example, using a software package (e.g., Ansoft HFSS). For example, designers preferably tune the parallelepiped length/to optimize the AR and then adjust the probe length lₚ to obtain a good match. Since the AR is virtually unaffected by lₚ, the proposed antenna can be optimized very easily.

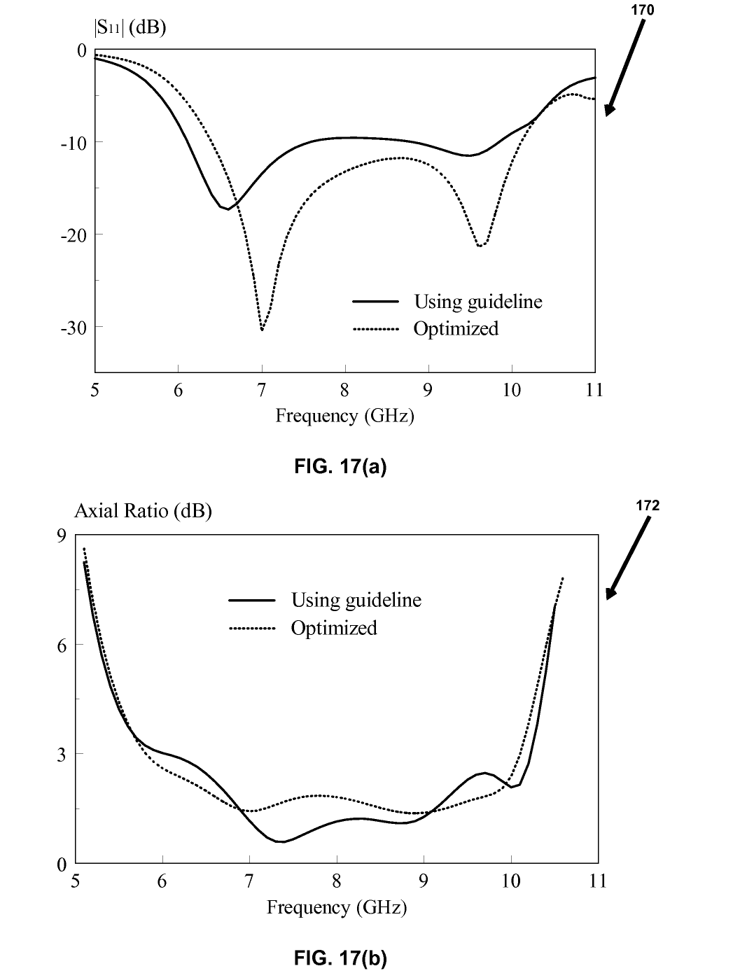

To verify the design guideline, a bird-nest antenna operating at f_{c}=8 GHz was designed. The direct parameter values obtained from the guideline are listed in Table III below. FIGS. 17(a) and 17(b) are graphs of the reflection coefficient 170 and AR 172, respectively, of the antenna obtained using the design guideline. With reference to the figures, reasonable initial results can be obtained with these parameter values. Next, tuning is done to optimize the antenna using HFSS. To compare with the initial results, the optimized reflection coefficient and AR are also displayed in FIGS. 17(a) and (b). The values of the tuned parameters are given in Table III below for ease of comparison. As can be observed from the table, the optimized impedance and AR bandwidths are 45% and 54.2%, respectively, validating the design approach.

Table III is a comparison between original and tuned design parameters based on the design guideline. The bird-nest antenna operates at 8 GHz: ∈ᵣ=15, α=30°, rₚ=0.63 mm.

TABLE III

| | Dielectric slab size | Ground plane | Distance | Probe length | Impedance | AR |
|---|---|---|---|---|---|---|
| | w × d × l (mm) | radius R (mm) | s₀ (mm) | lₚ (mm) | Bandwidth | Bandwidth |
| Guideline | 4.0 × 6.6 × 41 | 21.7 | 18.7 | 9.4 | — | — |
| Optimized | 4.0 × 6.6 × 45 | 21.7 | 18.7 | 8.6 | 45.0% | 54.2% |

While several aspects of the present invention have been described and depicted herein, alternative aspects may be effected by those skilled in the art to accomplish the same objectives. For example, the antenna of the invention can be operated at or off resonance. Accordingly, it is intended by the appended claims to cover all such alternative aspects as fall within the true spirit and scope of the invention.

1. An omnidirectional circularly polarized (CP) antenna, comprising:
a feeding probe capable of emitting a linearly polarized (LP) omnidirectional radiation pattern, wherein the feeding probe is a monopole; and
a polarizer electrically coupled to the feeding probe, the polarizer comprising a plurality of grating dielectric elements, wherein the polarizer is capable of converting the LP radiation pattern into an omnidirectional CP radiation pattern.

2. The omnidirectional circularly polarized antenna of claim 1, further comprising a ground plane.

3. The omnidirectional circularly polarized antenna of claim 1, wherein the plurality of grating dielectric elements are parasitic, evenly spaced and angularly surround the probe.

4. The omnidirectional circularly polarized antenna of claim 3, wherein the plurality of grating dielectric elements comprise parallelepipeds.

5. The omnidirectional circularly polarized antenna of claim 3, wherein the plurality of grating dielectric elements each comprises one of a curved shape pattern, a shape pattern along a length thereof, and a corrugated shape pattern.

6. The omnidirectional circularly polarized antenna of claim 3, wherein the plurality of parasitic elements are operated at resonance.

7. The omnidirectional circularly polarized antenna of claim 3, wherein the plurality of parasitic elements are operated off resonance.

8. The omnidirectional circularly polarized antenna of claim 1, wherein the CP radiation pattern comprises a left-hand radiation pattern.

9. The omnidirectional circularly polarized antenna of claim 1, wherein the CP radiation pattern comprises a right-hand radiation pattern.

10. The omnidirectional circularly polarized antenna of claim 1, wherein the antenna has a reflection coefficient of less than about −10 dB and an axial ratio of below about 3 dB.

11. The omnidirectional circularly polarized antenna of claim 10, wherein the plurality of grating dielectric elements have a dielectric constant of about 7 to about 50.

12. The omnidirectional circularly polarized antenna of claim 1, wherein the CP radiation pattern comprises a conical beam CP radiation pattern.

13. The omnidirectional circularly polarized antenna of claim 1, wherein the feeding probe comprises an inner conductor of a subminiature version A (SMA) radio frequency (RF) coaxial connector.

14. The omnidirectional circularly polarized antenna of claim 1, wherein the feeding probe comprises a meander probe.

15. The omnidirectional circularly polarized antenna of claim 1, wherein the feeding probe has roughly a cone-like shape.

16. The omnidirectional circularly polarized antenna of claim 1, further comprising a circular ground plane on which the feeding probe and polarizer are situated.

17. The omnidirectional circularly polarized antenna of claim 16, wherein the circular ground plane has a radius of about half of an intended wavelength of the CP antenna.

18. A method of generating an omnidirectional circularly polarized (CP) radiation pattern, the method comprising:
providing an omnidirectional CP antenna, comprising:
a feeding probe capable of emitting an omnidirectional linearly polarized (LP) omnidirectional radiation pattern, wherein the feeding probe is a monopole; and
a polarizer electrically coupled to the feeding probe, the polarizer comprising a plurality of grating dielectric elements;
exciting the feeding probe to emit an omnidirectional LP radiation pattern; and
converting the LP radiation pattern to an omnidirectional CP radiation pattern via the polarizer.

19. The method of claim 18, wherein the plurality of grating dielectric elements are parasitic, evenly spaced and angularly surround the probe.

20. The method of claim 19, wherein the plurality of grating dielectric elements comprise parallelepipeds.

21. The method of claim 19, wherein the plurality of grating dielectric elements each comprises one of a curved shape pattern, a shape pattern along a length thereof, and a corrugated shape pattern.

22. The method of claim 19, wherein the plurality of parasitic elements are operated at resonance.

23. The method of claim 19, wherein the plurality of parasitic elements are operated off resonance.

24. The method of claim 18, wherein the antenna has a reflection coefficient of less than about −10 dB and an axial ratio of below about 3 dB.

25. The method of claim 24, wherein the plurality of grating dielectric elements have a dielectric constant of about 7 to about 50.

26. The method of claim 18, wherein the CP radiation pattern comprises an omnidirectional conical beam CP radiation pattern.

27. The method of claim 18, wherein the feeding probe comprises an inner conductor of a subminiature version A (SMA) radio frequency (RF) coaxial connector.

28. The method of claim 18, wherein the feeding probe comprises a meander probe.

29. The method of claim 18, wherein the feeding probe has roughly a cone-like shape.

30. The method of claim 18, wherein the CP antenna further comprises a circular ground plane on which the feeding probe and polarizer are situated, and wherein the providing comprises first choosing a radius for the ground plane.

31. The method of claim 30, wherein the choosing comprises choosing a radius for the ground plane of about half of an intended wavelength of the antenna.
